(19) United States
(12) Patent Application Publication
(10) Pub. No.: US 2012/0169043 A1
(43) Pub. Date: Jul. 5, 2012

(54) FLOW TOLERANT ACTUATING DEVICE AND METHOD OF DESENSITIZING AN ACTUATOR TO FLUID FLOW

(75) Inventor: Richard YingQing Xu, Tomball, TX (US)

(73) Assignee: BAKER HUGHES INCORPORATED, Houston, TX (US)

(21) Appl. No.: 12/983,560

(22) Filed: Jan. 3, 2011

(51) Int. Cl. F16L 37/06

(52) U.S. Cl. 285/306

(57) ABSTRACT

A flow tolerant actuating device includes, a first tubular having a first portion with a first minimum radial dimension, a second tubular surrounding the first tubular that is cyclically movable relative thereto having a second minimum radial dimension, and a protrusion extending from the second tubular having a third minimum radial dimension. The third minimum radial dimension is greater than the first minimum radial dimension and less than the second minimum radial dimension. The protrusion is positioned relative to the first minimum radial dimension in an upstream direction relative to an anticipated fluid flow direction, and the protrusion is configured to reduce downstream forces on the first tubular due to fluid flow.

### BACKGROUND

Tubular actuators are often actuated by pressure built upstream of a plug seated at a member movable within a tubular. Fluid flowing past the seat alone (i.e. without a plug seated thereagainst), can generate forces sufficient to cause premature movement of the movable member. Depending upon specifics of an application such movement can be troublesome. Operators of such systems are therefore desirous of devices and methods to overcome the foregoing drawback.

### BRIEF DESCRIPTION

Disclosed herein is a flow tolerant actuating device. The device includes, a first tubular having a first portion with a first minimum radial dimension, a second tubular surrounding the first tubular that is cyclically movable relative thereto having a second minimum radial dimension, and a protrusion extending from the second tubular having a third minimum radial dimension. The third minimum radial dimension is greater than the first minimum radial dimension and less than the second minimum radial dimension. The protrusion is positioned relative to the first minimum radial dimension in an upstream direction relative to an anticipated fluid flow direction, and the protrusion is configured to reduce downstream forces on the first tubular due to fluid flow.

Further disclosed herein is a method of desensitizing an actuator to fluid flow. The method includes, positioning a first tubular within a second tubular the first tubular having a first minimum radial dimension that is smaller than a second minimum radial dimension of the second tubular, flowing fluid through the first tubular and the second tubular. The method further includes directing the flowing fluid to a smaller radial dimension than the second minimum radial dimension upstream of the first minimum radial dimension.

### BRIEF DESCRIPTION OF THE DRAWINGS

The following descriptions should not be considered limiting in any way. With reference to the accompanying drawings, like elements are numbered alike:

FIG. 1 depicts a cross sectional view of a flow tolerant actuating device disclosed herein; and

FIG. 2 depicts a cross sectional view of an alternate embodiment of a flow tolerant actuating device disclosed herein.

### DETAILED DESCRIPTION

A detailed description of one or more embodiments of the disclosed apparatus and method are presented herein by way of exemplification and not limitation with reference to the Figures.

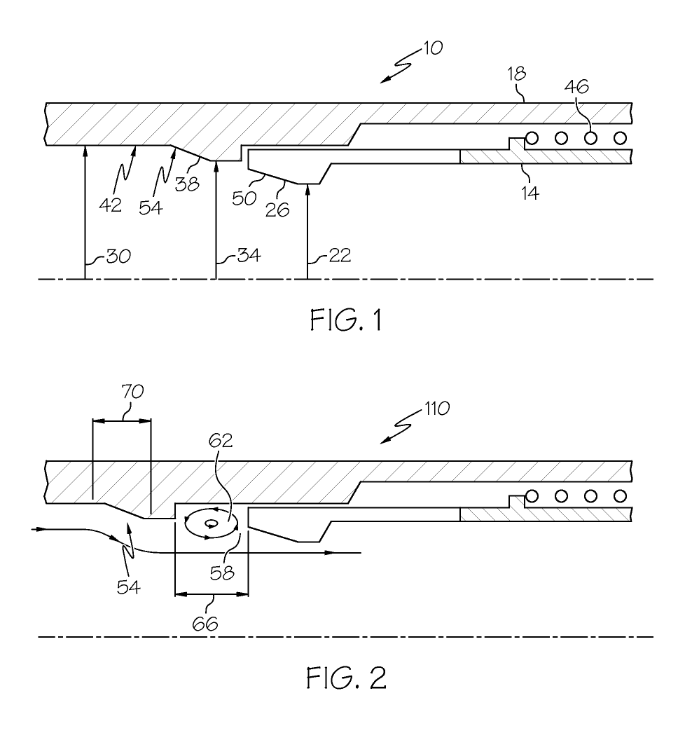

Referring to FIG. 1, a fluid flow tolerant actuating device disclosed herein is illustrated at 10. The device 10 includes a first tubular 14 that is surrounded by a second tubular 18. Movement of the first tubular 14 relative to the second tubular 18 causes the device to cycle. A counter (not shown) counts the number of cycles. After a selected number of cycles has been completed additional movement of the first tubular 14 relative to the second tubular 18 causes actuation of the device 10. The first tubular 14 has a minimum radial dimension 22 on a portion 26 that is smaller than a minimum radial dimension 30 of the second tubular 18 and a minimum radial dimension 34 of a protrusion 38 that extends from a surface 42 of the second tubular 18. Viscous drag and pressure drop generated by flowing fluid acting on the minimum radial dimension 22 create a downstream force on the first tubular 14. If the downstream force due to fluid flow is of sufficient magnitude to overcome an upward bias generated by a biasing member 46, illustrated herein as a compression spring, then the fluid flow can cause the first tubular 14 to move resulting in cycling of the device 10.

The actuating device 10 disclosed herein, however, is configured to prevent cycling in response to fluid flow alone. In fact, the actuating device 10 may be configured to cycle specifically in response only to pressure built against a plug or ball (not shown) that is seated at a defeatable seat 50 on the portion 26. As such, the protrusion 38 disclosed herein is configured to reduce downstream forces on the first tubular 14 due to fluid flow, thereby avoiding undesirable cycling due to fluid flow alone. In essence the device 10 desensitizes the actuating device 10 to the cycling effects of fluid flow. Avoidance of such undesirable cycling can be financially beneficial to operators. In a downhole hydrocarbon recovery system, for example, employing a counter designed to allow several plugs to pass a defeatable seat before preventing passage of a plug, erroneous cycling due to fluid flow can prevent passage of a plug earlier than anticipated. Such premature pluggage can result in a need to run an intervention to remove the non-passing plug, thereby delaying completion and production from the well.

The protrusion 38 attached to the second tubular 18 disclosed herein is key to preventing undesirable cycling of the device 10. This is due to the fact that a magnitude of a pressure drop in response to flowing fluid (and thus longitudinal force on the tubulars 14, 18 resulting therefrom) is determined, at least in part, by changes in radial dimensions that the flow encounters. As such, by making the minimum radial dimension 34 closer in size to the minimum radial dimension 22 than to the minimum radial dimension 30 a majority of the longitudinal force generated can be experienced by the protrusion 38 rather than by the first tubular 14. And, by attaching the protrusion 38 to the second tubular 18 the majority of the force is carried by the second tubular 18. An additional benefit of setting the dimensions 22, 20, 34 as discussed is the minimization of unintended cycling that could occur due to tools catching on the minimum radial dimension 22 while running such tools through the tubulars 14 and 18. It should be noted that making the minimum radial dimension 34 smaller than the minimum radial dimension 22 would also decrease both the fluid forces acting upon the first tubular 14 and chances of a tool catching on the first tubular 14 while running thereby, doing so would make cycling and actuation of the device 10 with a plug or ball impractical since the plug or ball would catch on the minimum radial dimension 34 instead of the minimum radial dimension 22 of the portion 26, as intended.

Another feature that can decrease forces on the first tubular 14 due to fluid flow is a tapered surface 54 that extends from the minimum radial dimension 34 to the minimum radial dimension 30 on an upstream side of the minimum radial dimension 34 of the protrusion 38. The tapered surface 54 may be a frustoconical surface that acts as a ramp to both fluid flowing there past and to tools being run therethrough.

Referring to FIG. 2, an alternate embodiment of a flow tolerant actuating device is illustrated at 110. The device 110 is similar to that of device 10, therefore only the differences will be described herein. Also like elements from the two devices 10, 110 will be identified with the same reference characters. The primary difference between the two devices 10, 110 is the addition of a longitudinal gap 58 between the portion 26 of the first tubular 14 and the protrusion 38 in the device 110. The gap 58 generates a vortex 62 therewithin in response to fluid flow. The vortex 62 creates a low pressure directly upstream of the portion 26 thereby generating a force on the first tubular 14 in an upstream direction that will oppose any downstream forces and help to minimize unintended cycling of the device 110. Sizing of the gap 58 can influence the effectiveness of the gap 58. For example, selecting a longitudinal dimension 66 of the gap 58 that is no more than eight times the minimum radial dimension 34 should maintain a low pressure zone upstream of the first tubular 14. Additionally, a longitudinal dimension 70 of the surface 54 can influence a maximum size of the longitudinal dimension 66 of the gap 58 that will maintain a low pressure of the vortex 62. Increases in the longitudinal dimension 70, for example, can allow for increases in the longitudinal dimension 66 of the gap 58 that will maintain a low pressure of the vortex 62.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A flow tolerant actuating device comprising:
a first tubular having a first portion with a first minimum radial dimension;
a second tubular surrounding the first tubular being cyclically movable relative thereto having a second minimum radial dimension; and
a protrusion extending from the second tubular having a third minimum radial dimension, the third minimum radial dimension being greater than the first minimum radial dimension and less than the second minimum radial dimension, the protrusion being positioned relative to the first minimum radial dimension in an upstream direction relative to an anticipated fluid flow direction, the protrusion being configured to reduce downstream forces on the first tubular due to fluid flow.

2. The flow tolerant actuating device of claim 1, wherein the first portion is a defeatable plug seat.

3. The flow tolerant actuating device of claim 1, wherein the first tubular is biased in an upstream direction relative to the second tubular.

4. The flow tolerant actuating device of claim 1, wherein the protrusion extends annularly from the second tubular.

5. The flow tolerant actuating device of claim 1, wherein the protrusion is attached to the second tubular.

6. The flow tolerant actuating device of claim 1, wherein the third minimum radial dimension tapers to the second minimum radial dimension on an upstream side of the protrusion.

7. The flow tolerant actuating device of claim 1, wherein a longitudinal gap exists between a downstream extent of the protrusion and an upstream extent of the first tubular.

8. The flow tolerant actuating device of claim 7 wherein a longitudinal dimension of the longitudinal gap is less than eight times the first minimum radial dimension.

9. A method of desensitizing an actuator to fluid flow comprising:
positioning a first tubular within a second tubular the first tubular having a first minimum radial dimension that is smaller than a second minimum radial dimension of the second tubular;
flowing fluid through the first tubular and the second tubular; and
directing the flowing fluid to a smaller radial dimension than the second minimum radial dimension upstream of the first minimum radial dimension.

10. The method of method of desensitizing an actuator to fluid flow of claim 9, further comprising reducing longitudinal forces acting upon the first tubular from flowing fluid.

11. The method of desensitizing an actuator to fluid flow of claim 9, further comprising positioning a protrusion on an inner wall of the second tubular upstream of an upstream extent of the first tubular, the protrusion having a third minimum radial dimension that is greater than the first minimum radial dimension and less than the second minimum radial dimension.

12. The method of desensitizing an actuator to fluid flow of claim 11, further comprising positioning the protrusion so that a longitudinal gap exists between a downstream extent of the protrusion and an upstream extent of the first tubular.

13. The method of desensitizing an actuator to fluid flow of claim 11, further comprising generating a vortex downstream of the protrusion and upstream of the first tubular.
